(19) United States
(12) Patent Application Publication
(10) Pub. No.: US 2026/0181416 A1
(43) Pub. Date: Jun. 25, 2026

(54) METHODS TO SUPPORT MULTI-CELL LIFE CYCLE MANAGEMENT

(71) Applicant: InterDigital Patent Holdings, Inc., Wilmington, DE (US)

(72) Inventors: Dylan Watts, Montreal (CA); Oumer Teyeb, Montreal (CA); Patrick Tooher, Montreal (CA); Yugeswar Deenoo Narayanan Thangaraj, Chalfont, PA (US); Moon IL Lee, Melville, NY (US); Brian Martin, Farnham (GB); Virgil Comsa, Montreal (CA)

(73) Assignee: InterDigital Patent Holdings, Inc., Wilmington, DE (US)

(21) Appl. No.: 18/990,256

(22) Filed: Dec. 20, 2024

(51) Int. Cl. H04W 24/02; H04B 17/18; H04W 24/08

(52) U.S. Cl. CPC H04W 24/02; H04B 17/18; H04W 24/08

(57) ABSTRACT

A wireless transmit/receive unit (WTRU) may receive configuration information for a first cell and/or a second cell. The configuration information may comprise first and/or second network side conditions associated with the first cell and/or second cell. The WTRU may determine an applicability of an artificial intelligence or a machine learning (AI/ML) model to the first cell based on the first network side conditions associated with the first cell, and/or applicability of the AI/ML model to the second cell based on the second network side conditions associated with the second cell. The WTRU may send a first indication to a network device. The indication may indicate the applicability of the AI/ML model to the first cell and/or the applicability of the AI/ML model to the second cell. The WTRU may receive a reference AI/ML configuration for the AI/ML model for the first cell and/or for the second cell.

### BACKGROUND

The Third Generation Partnership Project (3GPP) has recently begun integration of artificial intelligence and machine learning (AI/ML) into 5G new radio (NR) to enhance air-interface performance (e.g., improved throughput, robustness, accuracy, and/or reliability, etc.) and/or reduce complexity and/or overhead. Selected features based on an assessment of their performance in comparison with traditional methods and/or the associated potential specification impact may include AI/ML for beam management, positioning, and/or CSI prediction.

Consideration of multiple features may enables a common AI/ML management framework, consisting of the following aspects: signalling and/or protocol aspects of Life Cycle Management (LCM); necessary signalling and/or mechanism(s) for LCM to facilitate model training, inference, performance monitoring, and/or data collection for both wireless transmit/receive unit (WTRU)-sided and/or network (NW)-sided models; and/or a signalling mechanism of applicable functionalities and/or models.

The current AI/ML framework may consider functionality-based LCM, wherein a functionality refers to an AI/ML feature enabled by configuration(s). Further, a network may indicate activation, deactivation, fallback, and/or switching of AI/ML functionality via 3GPP signaling (e.g., radio resource control (RRC), medium access control (MAC) control element (CE), and/or downlink control information (DCI)). To support the configuration and/or (de) activation of a functionality, the WTRU may report whether a functionality is applicable based on WTRU and/or network-side additional conditions (e.g., WTRU speed and/or number of antennas, etc.) and/or model availability at the WTRU. A WTRU may first be provided an AI/ML configuration and/or report whether the functionality is applicable based on the configuration. The WTRU may report one or more applicable functionalities and/or subsequently receive an AI/ML configuration.

### SUMMARY

A wireless transmit/receive unit (WTRU) may receive configuration information for a first cell and/or a second cell. The configuration information may comprise first network side conditions associated with the first cell and/or second network side conditions associated with the second cell. The WTRU may determine an applicability of an artificial intelligence or a machine learning (AI/ML) model to the first cell based on the first network side conditions associated with the first cell, and/or applicability of the AI/ML model to the second cell based on the second network side conditions associated with the second cell. The WTRU may send a first indication to a network device. The first indication may indicate the applicability of the AI/ML model to the first cell and/or the applicability of the AI/ML model to the second cell. The WTRU may receive a reference AI/ML configuration for the AI/ML model for the first cell and for the second cell. The WTRU may determine that a performance of an AI/ML operation on transmissions associated with the first cell or on transmissions associated with the second cell fell below a threshold. The AI/ML operation may be performed by the AI/ML model using the reference AI/ML configuration. The WTRU may send a second indication to the network device. The second indication may indicate that the performance of the AI/ML operation on transmissions associated with the first cell and/or on transmissions associated with the second cell fell below the threshold.

The network side conditions may comprise one or more of beam management conditions or an indication of a number of antennas at the network device. The reference AI/ML configuration may comprise an identification of the first cell and/or the second cell which the reference AI/ML configuration applies. The reference AI/ML configuration may comprise an indication that the reference AI/ML configuration applies to the first cell and/or the second cell. The reference AI/ML configuration may comprise an indication of a list of cells for which the reference AI/ML configuration applies.

The WTRU may receive an indication from the network to deactivate one or more of the first cell or the AI/ML model when the performance of the AI/ML operation on the transmissions associated with the first cell fell below the threshold. The WTRU may receive an indication from the network to deactivate one or more of the second cell or the AI/ML model when the performance of the AI/ML operation on the transmissions associated with the second cell fell below the threshold. The WTRU may deactivate one or more of the first cell when the performance of the AI/ML operation on the transmissions associated with the first cell fell below the threshold or the second cell when the performance of the AI/ML operation on the transmissions associated with the second cell fell below the threshold.

The WTRU may monitor one or more of the first cell when the performance of the AI/ML operation on the transmissions associated with the first cell fell below the threshold or the second cell when the performance of the AI/ML operation on the transmissions associated with the second cell fell below the threshold. The WTRU may activate one or more of the first cell if the first cell is deactivated and the performance of the AI/ML operation on the transmissions associated with the first cell rise above the threshold when the WTRU monitors the first cell or the second cell if the second cell is deactivated and the performance of the AI/ML operation on the transmissions associated with the second cell rise above the threshold when the WTRU monitors the second cell.

The WTRU My send a third indication to the network device. The third indication may indicate that the performance of the AI/ML operation on the transmissions associated with the first cell rises above the threshold or the performance of the AI/ML operation on the transmissions associated with the second cell rises above the threshold. The WTRU may receive an activation command from the network device. The activation command may indicate that the WTRU activate the first cell if the first cell rises above the threshold or that the WTRU activate the second cell if the second cell rises above the threshold. The WTRU may receive a second reference AI/ML configuration for the AI/ML model. The second reference AI/ML configuration for the AI/ML model may comprise one or more of revisions to the original reference AI/ML configuration for the AI/ML model and/or new configurations for operating the AI/ML model.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

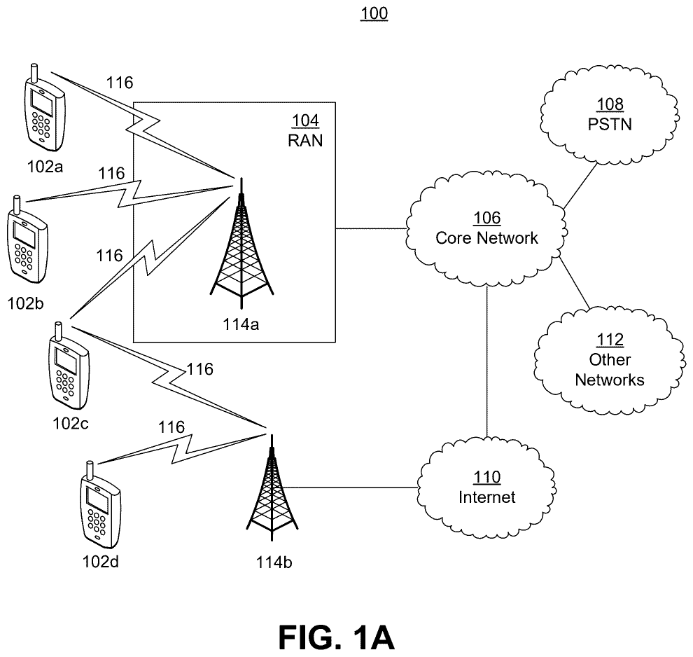

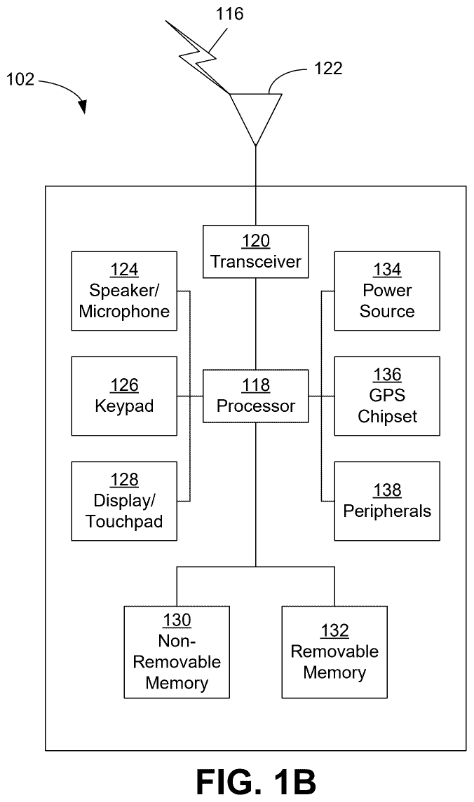

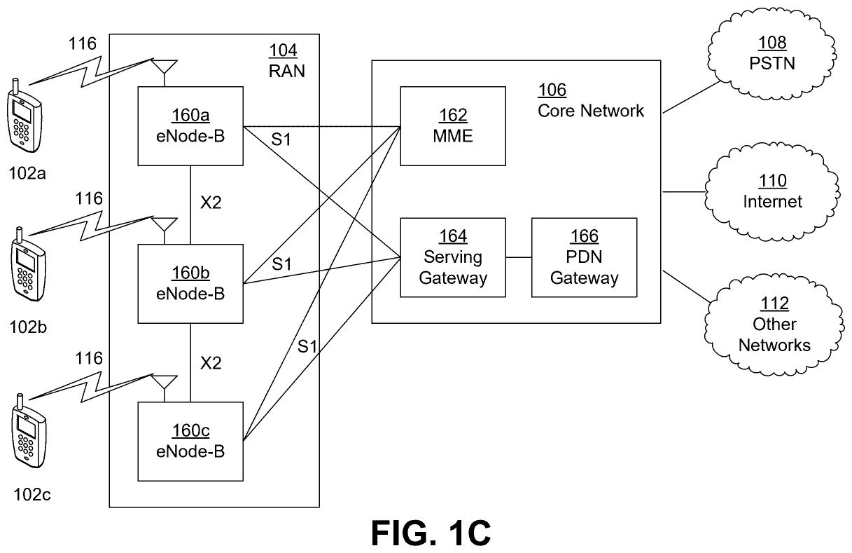

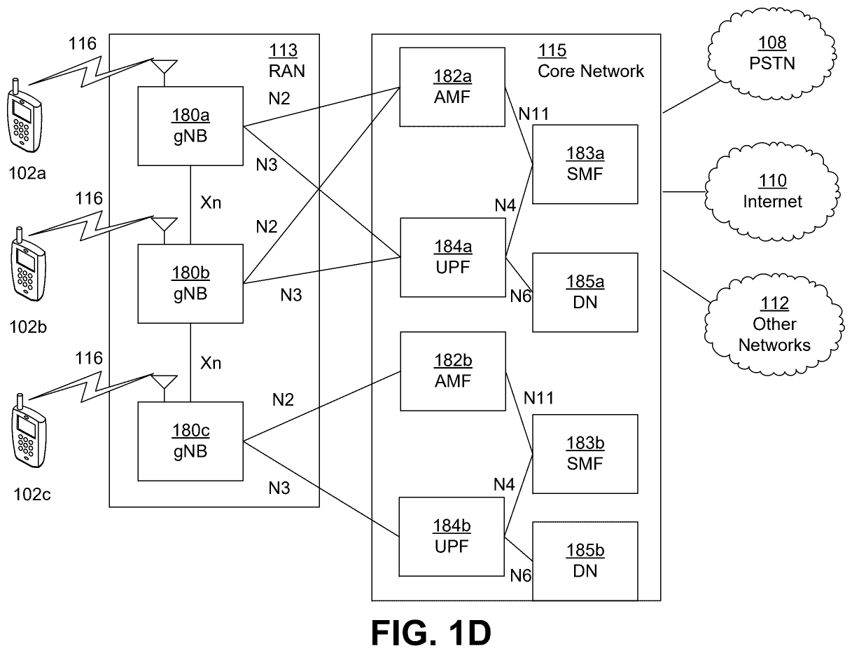

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

New radio (NR) may support dual connectivity (DC) operation whereby a multiple reception/transmission (Rx/Tx) wireless transmit/receive unit (WTRU) in RRC_CONNECTED may utilize radio resources provided by two distinct schedulers, located in two gNBs. Next generation radio access network (NG-RAN) may support NR-NR dual connectivity (NR-DC), in which a WTRU, also known as a user equipment (UE), may connect to one gNB that acts as a MN (master node) and/or another gNB that acts as a SN (secondary node). NR-DC may also be used when a WTRU connects to a single gNB, acting both as an MN and as a SN, and/or configuring both a master cell group and a (MCG) and a secondary cell group (SCG). When the WTRU configured with SCG, the WTRU is configured with two MAC entities: one MAC entity for the MCG and/or one MAC entity for the SCG.

In case of carrier aggregation (CA), the multi-carrier nature of the physical layer is exposed to the MAC layer for which one hybrid automatic request (HARQ) entity is required per serving cell. When CA is configured, the WTRU may have one radio resource control (RRC) connection with the network. At RRC connection establishment and/or re-establishment and/or handover, one serving cell may provide the new access stratum (NAS) mobility information. At RRC connection re-establishment/handover, one serving cell may provide the security input. This cell may be referred to as the Primary Cell (PCell). Depending on WTRU capabilities, Secondary Cells (SCells) may form together with the PCell as a set of serving cells. The configured set of serving cells for a WTRU therefore may comprise one PCell and one or more SCells. The reconfiguration, addition, and/or removal of SCells may be performed by RRC.

A WTRU configured with multiple cells (e.g., in a DC/CA scenario) may have several cells with very similar characteristics including network-side additional conditions (e.g., if the cells are co-located). Individually performing life cycle management (LCM) (e.g., applicability reporting, configuration, and/or activating/deactivating etc.) may therefore be unnecessary. Further, a WTRU and/or network may prioritize activation of a given AI/ML model and/or functionality if the AI/ML model and/or functionality can be applied across many cells. The AI/ML model and/or functionality may require activation/deactivation of the cells themselves to support AI/ML operation across multiple cells. Additionally or alternatively, the WTRU may wish to activate a particular functionality and/or determine which cell(s) to support operation of the AI/ML functionality.

AI/ML LCM (e.g., applicability reporting, inference configuration, NW-side additional conditions, and/or performance monitoring, etc.) is currently defined for a single serving cell in RRC Connected. There is no consideration for optimizations on how LCM can operate for a WTRU configured with multiple cells (e.g., DC/CA scenario).

A WTRU may receive configurations for PCell and/or one or more SCell(s) including their respective NW-side additional conditions. The WTRU may determine the applicability of an AI/ML model and/or functionality for each configured cell, groups configured cell(s) based on applicability of a given AI/ML model and/or functionality, and/or for each AI/ML functionality and/or model reports the group of applicable cell(s). The WTRU may receive “reference” AI/ML configuration(s) (e.g., inference, performance monitoring, and/or data collection etc.) for a given functionality and/or model and applies the AI/ML configuration(s) for all cell(s) within the indicated group. The WTRU may perform AI/ML operation on all cell(s) within the group and/or measures the performance of the AI/ML configuration per cell, deactivating underperforming cell(s).

The WTRU may receive configurations (e.g., via the RRC configuration message) for a PCell and one or more SCell(s) which may include NW-side additional conditions. The WTRU may determine the applicability of an AI/ML model/functionality for each configured cell. The WTRU may group the configured cell(s) based on applicability of a given AI/ML model/functionality. The WTRU may report the group of applicable configured cell(s) (e.g., via the RRC Reconfiguration complete message) for each AI/ML functionality and/or model. The WTRU may receive “reference” AI/ML configuration(s) (e.g., inference, performance monitoring, and/or data collection etc.) for a given functionality and/or model and/or applies the AI/ML configuration(s) for all cell(s) within the indicated group.

The WTRU may receive a delta inference configuration from the reference for one or more cells within the group. The WTRU may activate one or more deactivated SCell(s) belonging to the group (if not already active). The WTRU may deactivate one or more SCells not belonging to the group. The WTRU may perform AI/ML operation on all cell(s) within the group and/or measures the performance of the AI/ML configuration per cell.

The WTRU may determine that the AI/ML performance on a cell within the group has fallen below a configured threshold. If the underperforming cell is the PCell, the WTRU may deactivate AI/ML functionality for all cell(s) within the group. If the underperforming cell is an SCell, the WTRU may deactivate AI/ML functionality for that particular cell. The WTRU may report that one or more cell(s) within the group may be underperforming and will not perform any action until subsequent direction from the network. The WTRU may directly deactivate an underperforming SCell (e.g., based on configuration from the network) and report afterwards. The WTRU may continue performance monitoring on underperforming cells within the group (e.g., which have AI/ML functionality deactivated).

If the performance of an underperforming cell exceeds one or more criteria, the WTRU may reactivate AI/ML operation the cell (e.g., autonomously). The WTRU may alternatively report that a deactivated cell exceeds one or more criteria. The WTRU may then receive an activation command. When the network switches and/or deactivates AI/ML functionality, the network may optionally indicate the WTRU to deactivate all cell(s) within a group which are running the model.

By grouping cell(s) based on applicability for a given functionality, the WTRU may efficiently apply and manage AI/ML operation across multiple cell(s) with similar NW-side additional conditions. This may include reduced signaling overhead by avoiding redundant inference configuration and/or coordinated (de) activation of cell(s) based on AI/ML performance.

Solutions described herein may support efficient LCM for AI/ML operation across multiple configured cells with similar applicability. The following terminology may be used herein: a “group reference configuration” may be one or more configuration(s) which apply to more than one cell (e.g., in response to a multi-cell applicability report). An “additional configuration” and/or “delta configuration” may be one or more configuration(s) that a WTRU may add and/or combine with a group reference configuration to obtain the full configuration for a given cell.

A WTRU may be provided with one or more configuration(s) for multi-cell LCM. Examples may include configurations to support one or more of: AI/ML operation; multi-cell AI/ML applicability reporting; multi-cell AI/ML configuration; multi-cell AI/ML operation; multi-cell AI/ML performance monitoring; and/or multi-cell cell management.

Multi-cell LCM may (e.g., additionally) be initiated if supported by both the WTRU and NW. A WTRU may indicate capability for one or more aspects of multi-cell LCM (e.g., prior to initiation of the procedure or reception of associated configurations). A NW may indicate support (e.g., per cell) for one or more aspects of multi-cell LCM. A WTRU may, for example, only initiate a procedure and/or expect configuration with a cell(s) which support the procedure. Solutions described herein support indication of WTRU capability, NW support, and/or the reception of one or more configurations for multi-cell LCM.

A capability may be required for multi-cell LCM. The capability may be related to all aspects of multi-cell LCM or one or more aspects. Support for multi-cell LCM may be reported by the WTRU and/or indicated by the network (e.g., on a cell-specific basis).

A WTRU may indicate capability and/or support for one or more aspects of multi-cell LCM. The WTRU may indicate a single capability to indicate support for all aspects of multi-cell LCM. The WTRU may report support for each aspect of multi-cell LCM. The WTRU may indicate support for one or more of the following: applicability determination for more than one cell; applicability reporting for more than one cell; multi-cell configuration based on a reference configuration; delta and/or additional configuration for a multi-cell scenario; multi-cell configuration release; multi-cell (de) activation; multi-cell performance monitoring evaluation; multi-cell performance monitoring reporting; performance-based cell (de) activation; and/or AI/ML functionality-based cell (de) activation.

The WTRU may report the capability of one or more of the above aspects of multi-cell LCM, e.g., via the WTRU capability transfer procedure. The WTRU may indicate capability and/or support via one or more of the following methods: random access, or use of one or more dedicated resources, use of random access preamble partitioning (e.g., a set of reserved preambles or random access occasions, and/or radio network temporary identifiers (RNTIs), etc.); upon RRC connection establishment and/or resumption (e.g., Msg3 and/or Msg5); upon request from the network (e.g., upon reception of the capability enquiry message); and/or WTRU assistance information.

The capability to support, perform, execute, and/or initiate one or more aspects of multi-cell LCM may be reliant and/or linked to one or more other configurations. The network may assume that a WTRU may be capable of one or more aspects of multi-cell LCM based on, e.g., the activation, state, and/or configuration one or more of the following: the configuration of an AI/ML model and/or functionality; activation of an AI/ML model and/or functionality; and/or availability of an AI/ML model and/or functionality.

The capability and/or support for initiation of one or more aspects of multi-cell LCM may be reliant on one or more characteristics of the WTRU. For example, one or more of the following: performance of an AI/ML model and/or functionality; WTRU speed; remaining WTRU power; WTRU processing ability; WTRU location (e.g. within a certain set of cells, using one of a set of specific beams, and/or global positioning system (GPS) location, etc.); when a particular type of service is in use, (e.g. related to one or more specific network slices and/or quality of service class identifiers (QCIs)).

If a WTRU is configured for multi-cell LCM and/or an associated configuration is not present and/or active and/or the WTRU characteristics are not suitable, the WTRU may assume that the procedure is temporarily disabled (e.g., the WTRU may not initiate the procedure) and/or inactive. The WTRU may indicate (e.g., subject to configuration) to the network that multi-cell LCM is temporarily inactive (e.g., via a MAC CE, UCI, and/or RRC signalling). The WTRU may also report the reason for why the procedure is inactive (e.g., a joint configuration is disabled and/or the WTRU characteristics are not suitable, etc.).

The network may indicate support for multi-cell LCM. Support for multi-cell LCM may be, per cell, per public land mobile network (PLMN), per frequency, per tracking area (TA), and/or per RAN notification area (RNA). The indication may be, e.g., a flag and/or bit in system information which indicates support for multi-cell LCM. The NW may indicate support for an aspect of the procedure (e.g., that the cell supports delta configuration but not a unified reference configuration). The network may indicate (e.g., within system information and/or via RRC configuration) a list of one or more cell(s) which support multi-cell LCM.

The WTRU may initiate multi-cell LCM and/or one or more aspects of multi-cell LCM subject to the network supporting the procedure. The WTRU may only resume AI/ML operation upon return to RRC connected if the cell has indicated support for multi-cell LCM.

The WTRU may receive configuration(s) to support one or more AI/ML operation(s). Examples may include configurations for model training, inference, performance monitoring, data collection, and/or applicability reporting.

A WTRU may receive configuration(s) for AI/ML model training. Examples of configuration(s) for model training may include, one or more of: criteria for updating a model; criteria for determining when a model is done training; criteria for downloading a new model; criteria for re-training a model; and/or configurations to train a model (e.g., duration of training, number of iterations etc.)

A WTRU may receive configuration(s) for AI/ML inference. Examples of configuration(s) for AI/ML inference may include one or more of: model(s) in which to perform inference; information characteristics needed for input; and/or NW-side additional conditions and/or associated ID(s) which the model has been trained on.

A WTRU may receive configuration(s) for AI/ML performance monitoring. Examples of configuration(s) for performance monitoring may include, for example, one or more of: when to perform performance monitoring (e.g., periodicity and/or duration, etc.); criteria for performance monitoring (e.g., thresholds); and/or criteria to report performance monitoring results (e.g., performance has dropped below a threshold).

A WTRU may receive configuration(s) for AI/ML data collection. Examples of configuration(s) for AI/ML data collection may include one or more of: measurement configuration(s); associated ID(s); NW-side additional conditions; limits on the amount of data collected; types of data and/or events to collect; triggers to report collected data; and/or formats to report collected data.

A WTRU may receive configuration(s) for AI/ML applicability reporting. Examples of configuration(s) for AI/ML applicability reporting may include one or more of: whether to proactively or reactively report the applicability; whether the WTRU can report non-applicability; whether the WTRU can transmit an update during the connected regarding the applicability of a model; and/or triggering conditions to report applicability (e.g., a functionality becomes non-applicable).

The WTRU may receive configuration(s) to support multi-cell applicability reporting and configuration. Configurations may be provided and/or applied for all cell(s) within a group or may be individually configured per cell.

A WTRU may receive configuration(s) for multi-cell applicability reporting. Examples of configuration(s) for multi-cell applicability reporting may include one or more of: whether the WTRU may report the applicability of multiple cell(s) at once; whether the WTRU can report the applicability for a deactivated cell; whether a WTRU may group cell(s) based on applicability; the number of cell(s) which may be grouped; and/or whether the WTRU reports group applicability to the PCell and/or any cell.

A WTRU may receive configuration(s) for multi-cell AI/ML operation. Examples of configuration(s) for multi-cell AI/ML operation may include one or more of: whether the WTRU may apply a reference configuration to more than one cell; whether the WTRU may receive and/or apply a delta configuration (e.g., for a given cell); whether the WTRU may request missing and/or updated configuration(s); whether the WTRU may continue AI/ML operation without a delta configuration; and/or whether the WTRU may maintain AI/ML configuration(s) on a deactivated cell.

The WTRU may receive configuration(s) to support multi-cell performance monitoring and cell management. Configurations may be provided and/or applied for all cell(s) within a group or may be individually configured per cell. A WTRU may receive configuration(s) for multi-cell performance monitoring. Examples of configuration(s) for multi-cell performance monitoring may include one or more of: support for multi-cell performance monitoring; whether the performance is evaluated based on the combination of cell(s) within the group; whether the performance of the group is evaluated individually; one or more threshold(s) associated either performance monitoring; one or more triggers to support reporting performance; and/or whether the WTRU may monitor a deactivated cell.

A WTRU may receive configuration(s) for multi-cell management. Examples of configuration(s) for multi-cell management may include one or more of: whether the WTRU may deactivate a cell based on AI/ML performance; whether the WTRU may activate a cell based on AI/ML performance; whether the WTRU may deactivate a cell based on AI/ML functionality and/or model (de) activation; and/or whether the WTRU may activate a cell based on AI/ML functionality and/or model (de) activation.

Methods to (re) acquire, adapt, and/or release configurations for multi-cell LCM may be necessary to ensure a WTRU may continue to maintain related AI/ML configuration(s) and/or AI/ML operation.

The WTRU may be provided with configurations for multi-cell LCM upon establishment and/or resumption of an RRC connection (e.g., within the RRC Setup/Resume message), upon handover (HO) to another cell (e.g., within a HO command and/or RRC reconfiguration message with a reconfiguration with sync, etc.), and/or at any time during an active RRC connection (e.g., RRC reconfiguration message without reconfiguration with sync). Configurations for multi-cell LCM may be indicated, configured, provided via one or more of the following signaling methods: SIB (e.g., a new SI block, or within another existing SIB), NAS, MAC CE, DCI, random access channel (RACH) (e.g., message 2 (MSG2), MSG4, and/or MSGB), RRC, PDCCH and/or PUSCH.

The WTRU may receive different information and/or components of a configuration for multi-cell LCM via different signaling methods. For example, the WTRU may receive some dedicated configuration aspects via RRC signalling (e.g., reference and/or delta configuration(s) for AI/ML operation), and/or some other configurations and/or information via system information (e.g., which cell(s) support multi cell LCM). If a WTRU is provided with a dedicated configuration and/or indication related to multi-cell LCM, the WTRU may override other common configuration information (e.g., received via broadcast signalling) and/or may combine the dedicated configuration with one or more pieces of common configuration information. The WTRU may use the most recently received information in the configuration regardless of the signalling method.

The WTRU may receive one or more alternative configurations using one signalling method (e.g., via system information or dedicated RRC signalling). Using another type of signalling (e.g., via dedicated RRC signalling or MAC CE) the network may select and/or indicate which of the one or more alternative configurations to apply.

The WTRU may receive a configuration based on a NW decision (e.g., upon release to RRC IDLE or RRC INACTIVE), such as when the WTRU indicates it is capable of multi-cell LCM. The WTRU may request to be configured for multi-cell LCM. The WTRU may request configuration(s) for multi-cell LCM, update existing configuration(s) for multi-cell LCM, and/or apply different configuration(s) for multi-cell LCM.

The WTRU may release related configurations for multi-cell LCM (e.g., all or one or more parts of a configuration), upon one or more of the following circumstances: the current serving cell does not support multi-cell LCM; the WTRU does not have an active, available, configured, or supported AI/ML functionality and/or model to require and/or perform multi-cell LCM.

A WTRU may adapt (e.g., change) one or more aspects of configuration(s) for multi-cell LCM based on the WTRU characteristics. Examples of these WTRU characteristics may include: WTRU speed and/or position; WTRU power and/or battery level; and/or WTRU processing capability and/or load.

Upon detection of change in WTRU characteristics, the WTRU may modify one or more aspects of the current configuration and/or apply a new configuration. How the WTRU detects which aspects of the configuration to change may be based on conditions associated with the configuration and/or aspect(s) of the configuration. For example, the WTRU may be provided with one or more threshold(s). If a threshold is exceeded (or if a value has fallen below a threshold) the WTRU may apply an alternative configuration and/or value for the same configuration.

A WTRU configured with multiple cells (e.g., in a DC/CA scenario) may be enhanced to support LCM for more than one cell at a time. By grouping cell(s) based on applicability for a given AI/ML functionality and/or model, a WTRU may efficiently apply and/or manage AI/ML operation across multiple cell(s) with similar NW-side additional conditions. This may include reduced signaling overhead by avoiding redundant AI/ML-related configuration.

Solutions described herein may support multi-cell applicability reporting and/or AI/ML-related configuration, including the identification, grouping, and/or reporting of configured cell(s) based on AI/ML functionality, applicability, and/or AI/ML-related configuration for multiple cell(s), including group reference configuration with cell specific delta configuration (if needed).

The WTRU may report the applicability for more than one cell at a time. Applicability determination may be based on the reception of necessary information (e.g., NW-side additional conditions and/or associated identifiers (ID) for configured cell(s). Cell(s) may then be subsequently grouped based on their applicability for a given functionality and efficiently reported to either the PCell and/or primary/secondary cell (PsCell).

The WTRU may determine the applicability of multiple configured cell(s) at once. To determine the applicability of multiple configured cell(s), the network may provide necessary information for each configured cell (e.g., NW-side additional conditions and/or associated ID). The network may provide such information, for example, within the cell configuration(s) for each cell. The network may provide necessary information to evaluate the applicability of a cell via other methods such as within system information. The PCell and/or PsCell may provide (e.g., via dedicated message) information needed to evaluate the applicability of one or more configured cell(s).

The information needed to determine the applicability of a configured cell may be unsolicited (e.g., the network provides such information as part of a typical configuration) or based on an explicit request from the WTRU. To obtain the necessary information, the WTRU may include, for example, one or more of the following within the request: a list of one or more cell(s) (e.g., via physical cell identities (PCI); which information the WTRU requires (e.g., NW-side additional conditions, associated ID, etc.); which AI/ML model/functionality the WTRU is checking the applicability for whether the cell is currently activated and/or deactivated.

The WTRU may (e.g., upon reception of necessary information) perform evaluation of the applicability of each configured cell. The WTRU may perform such evaluation for all configured AI/ML model(s) and/or functionalities, or a subset of AI/ML model(s)/functionalities. For example, each AI/ML functionality may be configured whether it is capable of multi-cell AI/ML operation. If the cell does not support multi-cell AI/ML, the WTRU may not include that cell in the evaluation of applicability reporting.

The network may request that the WTRU perform multi-cell applicability reporting for a specific AI/ML model and/or functionality (e.g., including necessary information to determine applicability for each cell). Upon reception of the request, the WTRU may determine which cell(s) among all configured cell(s) support the given functionality and/or AI/ML model. The WTRU may subsequently report back the list of cells to the network which are applicable for that functionality.

The network may request and/or require applicability reporting for a particular cell. For example, the WTRU may be configured with a deactivated SCell, and prior to SCell activation the network may wish to understand which AI/ML model(s) and/or functionalities the SCell may support. Upon receiving a request, the WTRU may determine and/or report back the applicability for the dormant and/or deactivated SCell. In another solution, the cell may not be configured. In another solution, upon activation of one or more cell(s), the WTRU may trigger applicability reporting for that cell.

The WTRU may group one or more cell(s) based on being applicable for a given functionality and/or model. A group or cell(s) may include, for example, a list of PCIs and the associated AI/ML model and/or functionality that the cell(s) are applicable for. The WTRU may then, for example, may report the applicable group of cell(s) at once for each configured cell. The WTRU may include, for example, a list of PCIs in which the given functionality or model is applicable.

The WTRU may group the AI/ML model and/or functionalities which are applicable for a particular cell. The WTRU may then, upon reporting the applicability to the PCell, include the group of applicability functionalities and/or AI/ML models for each configured cell.

The WTRU may only report the applicability of cell(s) which are active, or alternatively the WTRU may report the applicability for all configured cell(s). In other solutions, the WTRU may trigger an applicability report if one or more configured cell(s) is activated and/or deactivated. The WTRU may reports the list of applicable cell(s) to the PCell. The WTRU may report the applicable functionality(ies) to all cell(s) individually.

The WTRU may receive a configuration for AI/ML operation which may apply to more than one configured cell. Such reference configurations may apply to a group of applicable cell(s). The network may also provide cell-specific delta configuration(s) from the reference configuration, if necessary to support AI/ML operation on a given cell.

The WTRU may receive AI/ML related configuration(s) (e.g., configuration(s) for inference, performance monitoring, and/or data collection, etc. which may apply to more than one cell, herein referred to as a “group reference configuration”. This configuration may be received in response to a multi-cell applicability report.

The configuration(s) may be applied to all cell(s) within the applicable cell group, or a subset of cell(s) within the group. The configuration(s) may include additional information (e.g., to identify which cell(s) the configuration should be applied to). Examples of such information include, for example, one or more of the following: identification of the group of cells which the configuration applies to; an indication (e.g., a flag and/or bit) that this configuration applies to all cell(s) within the group; an indication (e.g., a flag and/or bit) that this configuration doesn't apply to all cell(s) within the group; a list of cell(s) (e.g., within a group) that the configuration applies to; an indication that additional delta configuration is needed (e.g., as described below).

Upon reception of a group reference configuration, the WTRU may apply the configuration(s) to all cell(s) within the group and/or the indicated subset of cell(s) (e.g., based on the additional information provided). If a cell requires an additional delta configuration (e.g., as described below), the WTRU may combine the group reference configuration with the delta configuration to receive the full AI/ML configuration.

The WTRU may receive one or more additional configuration(s) to apply in addition to the group reference configuration. These additional configuration(s) may include independent configuration(s) to apply to the group reference configuration and/or may contain a revision of one or more configuration(s) contained within the group reference configuration. In case the additional configuration may conflict with the group reference configuration, the WTRU may apply the value and/or configuration(s) provided within the additional configuration. The revised values within the configuration may be independently configured values or may be a delta value to the group reference configuration.

The additional configuration (or delta configuration) may be applied for a specific cell. In such case, the network may indicate the cell ID (e.g., PCI) along with the delta configuration in which the cell should apply prior to AI/ML operation.

The WTRU may be missing configuration(s) necessary to being AI/ML operation for the cell group. If the WTRU is expecting a delta configuration for a particular cell and/or cell(s), the WTRU may not activate and/or perform any operations related to the configuration until the full configuration has been received. This may apply to the individual cell (which may be missing the configuration), and/or the entire group of WTRUs configured for the AI/ML operation. The WTRU may have recently activated a dormant cell applicable cell but may be missing a particular configuration. In such case the WTRU may suspend AI/ML operation on the dormant cell until all related configuration(s) have been obtained. If the cell which is missing information is the PCell, the WTRU may suspend and/or terminate AI/ML operation until the full configuration is obtained.

The WTRU may need to update the configuration of one or more cell(s) within a configured cell group. The WTRU may transmit a request to update one or more configuration(s) within the cell group. The request may contain one or more pieces of the following information: the cell(s) which require an updated configuration; whether the cell is an SCell and/or PCell; the configuration(s) which require an update; preferred value(s) for the configuration; if the updated configuration applies to a single cell, the WTRU may suspend operation on the cell until the revised configuration is acquired. Additionally or alternatively, if the updated configuration is required for the group reference configuration, the WTRU may suspend AI/ML operation for all cell(s) within the group. If the updated configuration is for the PCell, the WTRU may suspend AI/ML operation for all cell(s) within the group.

The WTRU may release one or more configuration(s) related to multi-cell AI/ML operation. The release may apply to all cell(s) within the group, or for one or more individual cell(s). Additional information may be provided to the WTRU to determine which configuration(s) are to be released. The information may contain, for example, one or more of the following: whether the release applies to all cell(s) within the group; whether the release applies to a specific cell or cell(s) within the group, including identification of the particular cell; whether the cell which the release applies to is the PCell; whether the WTRU may continue AI/ML operation on other cell(s); and/or whether the release applies to the group reference configuration.

WTRU action(s) related to the configuration release may differ depending on which configuration(s) the release applies. For example, if the WTRU is indicated to release the group reference configuration, the WTRU may release the group reference configuration for all cell(s) and/or the delta configuration for all cell(s) (if configured). If the release applies to configurations for the PCell, the WTRU may also release the group reference configuration for all cell(s) and/or the delta configuration for all cell(s) (if configured).

The WTRU may release configurations for only one (or a specific) cell. For example, if the configuration release applies to the delta configuration for a given cell, the WTRU may release the delta configuration. If a particular cell is being deactivated, the WTRU may also release all configuration(s) specific to that cell. If the cell being deactivated is the PCell, the WTRU may release also the group reference configuration.

A WTRU configured with multiple cell(s) (e.g., in the dual carrier (DC)/CA scenario) may perform coordinated AI/ML operation across multiple cell(s) (e.g., with the same or similar NW-side additional conditions). To ensure that all cell(s) performing AI/ML operation adequately, the WTRU may extend performance monitoring to the multi-cell case. The WTRU may further use the outcome of such performance monitoring to inform decisions on cell (de) activation (e.g., to ensure that only the best cell(s) to operate an AI/ML model and/or functionality are configured at a given instance).

Solutions described herein may support AI/ML performance monitoring and cell management for a WTRU configured with multiple cell(s), including the evaluation of multiple cell(s) during performance monitoring and cell management for multi-cell AI/ML (e.g., cell (de) activation based on AI/ML performance and/or functionality management).

The WTRU may (de) activate a multi-cell AI/ML configuration. The configuration (de) activation may apply to all cell(s) within the group, or AI/ML operation may be individually (de) activated for a given cell within the group.

The network may provide additional assistance information for support WTRU determination of which cell(s) the (de) activated command applies. For example, the WTRU may be provided the following information within a multi-cell AI/ML activation command: an indication (e.g., a flag or bit) which indicated the WTRU should (de) activate AI/ML operation for all cell(s) within the group; an indication (e.g., a flag or bit) which indicates the WTRU should (de) activate AI/ML operation for a specific cell; one or more cell ID(s) in which the WTRU should apply the (de) activation command; and/or whether the WTRU should release related configuration(s) upon deactivation.

If the AI/ML operation is (de) activated on the PCell, the WTRU may terminate AI/ML operation on all cell(s) within the group. The WTRU may (de) activate AI/ML operation on cell(s) within a group based on the status of one or more related configuration(s). For example, if a delta configuration was released for a particular cell and/or the group reference configuration is insufficient to continue AI/ML operation on the cell after release of the delta configuration, the WTRU may terminate operation of AI/ML on that cell.

Deactivation of AI/ML operation may be based on performance of one or more cell(s), wherein if the performance of an individual cell falls below a criteria or threshold, the WTRU may deactivate AI/ML operation on that cell. If the cell in which performance fell below a threshold was the PCell, the WTRU may additionally deactivate AI/ML operation on all cell(s) within the group. If the performance of the group has fallen below a configured threshold, the WTRU may deactivate AI/ML operation on all cell(s) within the group. Similar solutions may also be applied based on the activation of AI/ML operation based on the performance of a cell or group of cell(s) increasing above a criteria and/or threshold.

The WTRU may monitor the performance of AI/ML operation for multiple configured cells. The WTRU may apply similar performance monitoring criteria across all cell(s) (e.g., within a group) or the WTRU may individually evaluate the performance of one or more cell(s) running the AI/ML operation.

In some solutions, the WTRU may be configured to monitor and evaluate the Ai/ML performance of a group of cells. In one solution, the WTRU may evaluate and monitor the performance for all cell(s) within the group by combining the performance of all cells within the group. Associated performance monitoring criteria will therefore apply to all cells within the group, and may include, for example, one or more of the following for all cell(s) within the group: the difference between a performed and predicted measurement is above a threshold; the difference between a performed and predicted measurement is below a threshold; the difference between a performed and predicted measurement is within a range; the average difference between X performed and predicted measurement is above a threshold; the average difference between X performed and predicted measurement is below a threshold; the average difference between X performed and predicted measurement is within a range; the difference between the average of X performed measurements and the average of X predicted measurement is above a threshold; the difference between the average of X performed measurements and the average of X predicted measurement is below a threshold; the difference between the average of X performed measurements and the average of X predicted measurement is within a range; the average difference between performed and predicted measurement within a time period is above a threshold; the average difference between performed and predicted measurement within a time period is below a threshold; the average difference between performed and predicted measurement within a time period is within a range; the difference between the average of performed measurements within a time period and the average predicted measurement within a time period is above a threshold; the difference between the average of performed measurements within a time period and the average predicted measurement within a time period is below a threshold; and/or the difference between the average of performed measurements within a time period and the average predicted measurement within a time period is within a range.

The WTRU may monitor the performance of each cell within the cell group individually. In this case, the WTRU may be individually configured with different performance monitoring criteria for each cell. Performance monitoring criteria may include one or more of the above conditions, but evaluated for a particular cell.

The WTRU may monitor the performance for each cell individually, however aggregate and/or combine results of the performance monitoring of each individual cell to determine the performance of the group. The WTRU may determine the performance of the cell group via one or more of the following methods: the performance may be satisfactory for all cell(s); the performance may be satisfactory for one cell; the performance may be satisfactory for X cell(s); the performance may be unsatisfactory for all cell(s); the performance may be unsatisfactory for one cell; and/or the performance may be unsatisfactory for X cell(s). Whether the WTRU performs performance monitoring as an aggregated group, individually, or individually and then combined, may depend on, e.g., network configuration and/or network request(s).

The WTRU may report the performance for a group of cells and/or individual cell(s) within a group. To determine when and/or what to report, the WTRU may be configured with one or more criteria and/or triggering conditions to report the performance of a cell group. Criteria and/or triggering conditions may include one or more of the following: the performance of a cell group satisfies one or more of the performance criteria (e.g., as described herein); the performance of a cell within a cell group satisfies one or more of the performance criteria (e.g., as described herein); the performance of a subset of cell(s) within a cell group satisfies one or more of the previously described performance criteria; the WTRU may be configured with time and/or location-based conditions, for example in the case of using non-terrestrial networks (NTN). Time and/or location-based conditions may include when the WTRU location is within a threshold distance from a reference location and/or when the absolute time measured at the WTRU is within a time window (e.g. between T1 and T2)

Upon satisfaction of one or more triggering conditions and/or criteria to report the performance of multiple cell(s), the WTRU may determine the contents of the performance monitoring report. The WTRU may include one or more of the following within the performance monitoring report: the outcome of the performance monitoring; which cell(s) are performing adequately; which cell(s) are not performing adequately; and/or the criteria which triggered the report. Whether the WTRU may report the performance of all cell(s) within the group, a specific cell or cell(s), and/or the aggregated performance of the group may depend on the triggering condition and/or criteria that caused the performance monitoring report. If the performance of the group has fallen below a configured threshold, then the WTRU may include the aggregated performance of the cell group. The WTRU may also include (e.g., based on network request) the individual cell(s) which are underperforming when the WTRU reports a group performance.

The WTRU may continue performance monitoring on underperforming cells within the group (e.g., which have AI/ML functionality deactivated). If the performance of an underperforming cell exceeds one or more criteria, the WTRU may reactivate AI/ML operation the cell (e.g., autonomously). The WTRU may alternatively report that a deactivated cell exceeds one or more criteria and/or then receive an activation command.

The WTRU may selectively (de) activate one or more configured cell(s) based on the AI/ML performance monitoring outcome and/or the AI/ML functionality management. For example, the WTRU may request to deactivate a configured cell where the AI/ML performance drops below a configured criteria and/or activate a dormant cell if the cell is applicable for a recently activated AI/ML functionality.

Based on the performance monitoring of cell(s) within a group, the WTRU may deactivate an underperforming cell. The WTRU may identify an underperforming cell, then autonomously deactivate the cell, and/or then report to the network after deactivation. The WTRU may report which cell(s) are under performing (e.g., via a performance monitoring report). The network may then issue a command to the WTRU to deactivate one or more underperforming cell(s). If the underperforming cell was the PCell, the WTRU may deactivate all associated cells.

Upon deactivation of a cell, the WTRU may remove the cell from the group and/or release all AI/ML-related configuration(s). The WTRU may maintain the AI/ML configuration(s) however remove the cell from the group. The WTRU may keep the deactivated cell within the group.

The WTRU may (de) activate one or more cell(s) based on AI/ML functionality management. For example, upon reception of a group reference AI/ML configuration(s) (e.g., inference, performance monitoring, data collection etc.) for a given functionality and/or model, the WTRU may apply the AI/ML configuration(s) for all cell(s) within the indicated group. The WTRU may activate one or more deactivated SCell(s) belonging to the group if not already activated.

If the WTRU is configured with one or more cell(s) not within the group, the WTRU may deactivate one or more SCells not belonging to the group. If the network deactivates the AI/ML operation for a group of cell(s), the network may optionally indicate the WTRU to deactivate all cell(s) within a group which are running the model. A WTRU may determine which AI/ML functionality is preferrable. The WTRU may then request that a subset of cell(s) be activated to support a specific functionality.

A solution for LCM and/or cell management in a multi-cell scenario is as follows: The WTRU may receive configurations (e.g., via the RRC configuration message) for a PCell and one or more SCell(s) which may include NW-side additional conditions. The WTRU may determine the applicability of an AI/ML model/functionality for each configured cell. The WTRU may group the configured cell(s) based on applicability of a given AI/ML model/functionality. The WTRU may report the group of applicable configured cell(s) (e.g., via the RRC Reconfiguration complete message) for each AI/ML functionality and/or model. The WTRU may receive “reference” AI/ML configuration(s) (e.g., inference, performance monitoring, and/or data collection etc.) for a given functionality and/or model and/or applies the AI/ML configuration(s) for all cell(s) within the indicated group.

The WTRU may receive a delta inference configuration from the reference for one or more cells within the group. The WTRU may activate one or more deactivated SCell(s) belonging to the group (if not already active). The WTRU may deactivate one or more SCells not belonging to the group. The WTRU may perform AI/ML operation on all cell(s) within the group and/or measures the performance of the AI/ML configuration per cell.

The WTRU may determine that the AI/ML performance on a cell within the group has fallen below a configured threshold. If the underperforming cell is the PCell, the WTRU may deactivate AI/ML functionality for all cell(s) within the group. If the underperforming cell is an SCell, the WTRU may deactivate AI/ML functionality for that particular cell. The WTRU may report that one or more cell(s) within the group may be underperforming and will not perform any action until subsequent direction from the network. The WTRU may directly deactivate an underperforming SCell (e.g., based on configuration from the network) and report afterwards. The WTRU may continue performance monitoring on underperforming cells within the group (e.g., which have AI/ML functionality deactivated).

If the performance of an underperforming cell exceeds one or more criteria, the WTRU may reactivate AI/ML operation the cell (e.g., autonomously). The WTRU may alternatively report that a deactivated cell exceeds one or more criteria. The WTRU may then receive an activation command. When the network switches and/or deactivates AI/ML functionality, the network may optionally indicate the WTRU to deactivate all cell(s) within a group which are running the model.

1. A wireless transmit/receive unit (WTRU) comprising:
a processor and memory, wherein the processor is configured to:
receive configuration information for a first cell and a second cell, wherein the configuration information comprises first network side conditions associated with the first cell and second network side conditions associated with the second cell;
determine an applicability of an artificial intelligence or a machine learning (AI/ML) model to the first cell based on the first network side conditions associated with the first cell, and applicability of the AI/ML model to the second cell based on the second network side conditions associated with the second cell;
send a first indication to a network device, wherein the first indication indicates the applicability of the AI/ML model to the first cell and the applicability of the AI/ML model to the second cell;
receive a reference AI/ML configuration for the AI/ML model for the first cell and for the second cell;
determine that a performance of an AI/ML operation on transmissions associated with the first cell or on transmissions associated with the second cell fell below a threshold, wherein the AI/ML operation is performed by the AI/ML model using the reference AI/ML configuration;
activate or deactivate the first cell based on a comparison between the performance of the AI/ML operation on the transmissions associated with the first cell and the threshold, or activate or deactivate the second cell based on a comparison between the performance of the AI/ML operation on the transmissions associated with the second cell and the threshold; and
send a second indication to the network device, wherein the second indication indicates the comparison between the performance of the AI/ML operation on transmissions associated with the first cell and the threshold or the comparison between the transmissions associated with the second cell and the threshold.

2. The WTRU of claim 1, wherein one or more of the first or the second network side conditions comprise one or more of beam management conditions or an indication of a number of antennas at the network device.

3. The WTRU of claim 1, wherein the reference AI/ML configuration comprises an identification of the first cell and the second cell which the reference AI/ML configuration applies.

4. The WTRU of claim 1, wherein the reference AI/ML configuration comprises an indication that the reference AI/ML configuration applies to the first cell and the second cell.

5. The WTRU of claim 1, wherein the reference AI/ML configuration comprises an indication of a list of cells for which the reference AI/ML configuration applies.

6. The WTRU of claim 1, wherein the processor is further configured to:
receive an indication from the network to deactivate one or more of the first cell or the AI/ML model when the performance of the AI/ML operation on the transmissions associated with the first cell fell below the threshold; and
receive an indication from the network to deactivate one or more of the second cell or the AI/ML model when the performance of the AI/ML operation on the transmissions associated with the second cell fell below the threshold.

7. The WTRU of claim 1, wherein the processor is further configured to:
deactivate the first cell when the performance of the AI/ML operation on the transmissions associated with the first cell fell below the threshold or deactivate the second cell when the performance of the AI/ML operation on the transmissions associated with the second cell fell below the threshold.

8. The WTRU of claim 1, wherein the processor is further configured to:
monitor one or more of the first cell when the performance of the AI/ML operation on the transmissions associated with the first cell fell below the threshold or the second cell when the performance of the AI/ML operation on the transmissions associated with the second cell fell below the threshold; and
activate the first cell if the first cell is deactivated and the performance of the AI/ML operation on the transmissions associated with the first cell rise above the threshold when the WTRU monitors the first cell or activate the second cell if the second cell is deactivated and the performance of the AI/ML operation on the transmissions associated with the second cell rise above the threshold when the WTRU monitors the second cell.

9. The WTRU of claim 8, wherein the processor is further configured to:
send a third indication to the network device, wherein the third indication indicates that the performance of the AI/ML operation on the transmissions associated with the first cell rises above the threshold or the performance of the AI/ML operation on the transmissions associated with the second cell rises above the threshold; and
receive an activation command from the network device, wherein the activation command indicates that the WTRU activate the first cell if the first cell rises above the threshold or that the WTRU activate the second cell if the second cell rises above the threshold.

10. The WTRU of claim 1, wherein the processor is further configured to:
receive a second reference AI/ML configuration for the AI/ML model, wherein the second reference AI/ML configuration for the AI/ML model comprises one or more of revisions to the original reference AI/ML configuration for the AI/ML model or new configurations for operating the AI/ML model.

11. A method implemented by a wireless transmit/receive unit (WTRU), the method comprising:
receiving configuration information for a first cell and a second cell, wherein the configuration information comprises first network side conditions associated with the first cell and second network side conditions associated with the second cell;
determining an applicability of an artificial intelligence or a machine learning (AI/ML) model to the first cell based on the first network side conditions associated with the first cell, and applicability of the AI/ML model to the second cell based on the second network side conditions associated with the second cell;
sending a first indication to a network device, wherein the first indication indicates the applicability of the AI/ML model to the first cell and the applicability of the AI/ML model to the second cell;
receiving a reference AI/ML configuration for the AI/ML model for the first cell and for the second cell;
determining that a performance of an AI/ML operation on transmissions associated with the first cell or on transmissions associated with the second cell fell below a threshold, wherein the AI/ML operation is performed by the AI/ML model using the reference AI/ML configuration;
activating or deactivating the first cell based on a comparison between the performance of the AI/ML operation on the transmissions associated with the first cell and the threshold, or activating or deactivating the second cell based on a comparison between the performance of the AI/ML operation on the transmissions associated with the second cell and the threshold; and
sending a second indication to the network device, wherein the second indication indicates the comparison between the performance of the AI/ML operation on transmissions associated with the first cell and the threshold or the comparison between the transmissions associated with the second cell and the threshold.

12. The method of claim 11, wherein one or more of the first or the second network side conditions comprise one or more of beam management conditions or an indication of a number of antennas at the network device.

13. The method of claim 11, wherein the reference AI/ML configuration comprises an identification of the first cell and the second cell which the reference AI/ML configuration applies.

14. The method of claim 11, wherein the reference AI/ML configuration comprises an indication that the reference AI/ML configuration applies to the first cell and the second cell.

15. The method of claim 11, wherein the reference AI/ML configuration comprises an indication of a list of cells for which the reference AI/ML configuration applies.

16. The method of claim 11, further comprising:
receiving an indication from the network to deactivate one or more of the first cell or the AI/ML model when the performance of the AI/ML operation on the transmissions associated with the first cell fell below the threshold; and
receiving an indication from the network to deactivate one or more of the second cell or the AI/ML model when the performance of the AI/ML operation on the transmissions associated with the second cell fell below the threshold.

17. The method of claim 11, further comprising:
deactivating the first cell when the performance of the AI/ML operation on the transmissions associated with the first cell fell below the threshold or deactivate the second cell when the performance of the AI/ML operation on the transmissions associated with the second cell fell below the threshold.

18. The method of claim 11, further comprising:
monitoring one or more of the first cell when the performance of the AI/ML operation on the transmissions associated with the first cell fell below the threshold or the second cell when the performance of the AI/ML operation on the transmissions associated with the second cell fell below the threshold; and
activating the first cell if the first cell is deactivated and the performance of the AI/ML operation on the transmissions associated with the first cell rise above the threshold when the WTRU monitors the first cell or activate the second cell if the second cell is deactivated and the performance of the AI/ML operation on the transmissions associated with the second cell rise above the threshold when the WTRU monitors the second cell.

19. The method of claim 18, further comprising:
sending a third indication to the network device, wherein the third indication indicates that the performance of the AI/ML operation on the transmissions associated with the first cell rises above the threshold or the performance of the AI/ML operation on the transmissions associated with the second cell rises above the threshold; and
receiving an activation command from the network device, wherein the activation command indicates that the WTRU activate the first cell if the first cell rises above the threshold or that the WTRU activate the second cell if the second cell rises above the threshold.

20. A wireless transmit/receive unit (WTRU) comprising:
a processor and memory, wherein the processor is configured to:
receive configuration information for a first cell and a second cell, wherein the configuration information comprises first network side conditions associated with the first cell and second network side conditions associated with the second cell;
determine an applicability of an artificial intelligence or a machine learning (AI/ML) model to the first cell based on the first network side conditions associated with the first cell, and applicability of the AI/ML model to the second cell based on the second network side conditions associated with the second cell;
send an indication, wherein the indication indicates the applicability of the AI/ML model to the first cell and the applicability of the AI/ML model to the second cell; and
receive a reference AI/ML configuration for the AI/ML model, wherein the reference AI/ML configuration applies to the first cell and to the second cell.
